(19) United States
(12) Patent Application Publication
(10) Pub. No.: US 2004/0201898 A1
(43) Pub. Date: Oct. 14, 2004

(54) Light-homogenizing device and optical apparatus with light-homogenizing device

(75) Inventors: Sean Chang, Taoyuan City (TW); Albert Lin, Chang Hwa Hsien (TW)

Correspondence Address: LOWE HAUPTMAN GILMAN AND BERNER, LLP, 1700 DIAGONAL ROAD, SUITE 300 /310, ALEXANDRIA, VA, 22314, US

(73) Assignee: DELTA ELECTRONICS, INC.

(21) Appl. No.: 10/444,975

(22) Filed: May 27, 2003

(30) Foreign Application Priority Data
Apr. 11, 2003 (TW) 92205656

(51) Int. Cl. G02F 1/00; G02B 26/00; G02B 27/12

(52) U.S. Cl. 359/640

(57) ABSTRACT

The specification discloses a light-homogenizing device configured between a light source and a light valve. The device has a light-entering surface and a light-exiting surface. In particular, the light-entering surface is square. The shape of the light-exiting surface matches with that of the active region in the light valve.

### BACKGROUND OF THE INVENTION

1. Field of Invention

The invention relates to a light-homogenizing device that receives light and delivers homogeneous light. More particularly, the invention pertains to a light-homogenizing device that receives inhomogeneous light while sends out homogeneous light and can reduce the spreading angles.

2. Related Art

A worldwide growing trend in video technology is digitalization. In comparison with conventional display devices, the digital display for processing digital data can more accurately recover the original colors of an image, without sacrifice in the brightness and reliability of the image. Therefore, the digital display becomes more important.

A key technology in the digital display is in the digital micro-mirror device (DMD), which is a semiconductor optical switch of the size of a nail. The DMD is comprised of thousands of tiny mirrors, each of which has a rotating device on its back so that all of them can move independently. The basic principle of a DLP is to project light from a source to the micro-mirrors of the DMD (which are like points on the projected screen). Afterwards, the image source is used to determine whether any point on the screen is on or off. If a point is on, the micro-mirror rotates to the correct position to reflect light out; if a point is off, on the other hand, then the micro-mirror reflects light to another direction so that it is dark on the screen.

In the conventional digital displays, light is emitted from a light source and converged by a lamp reflector. After color selection of a color wheel, the light passes through a light tunnel to become homogeneous. Through the action of a relay lens set, the homogeneous light is projected to an appropriate area on the DMD chip.

The rotation angles for on and off on the DMD chip differ by about 10 to 12 degrees. When the spreading angle of the DMD chip is larger than the difference, light may enter the projection end, resulting in a small brightness in the output signal. We call this the “light leaking phenomenon.” Such a phenomenon will reduce the contrast ratio (i.e. the brightness ratio between bright and dark) of the projection system.

With reference to FIGS. 1A and 1B, the conventional light tunnel 100 is a solid transparent pillar with a rectangular cross section or a rectangular hollow pillar consisted of reflective mirrors 102. When light enters the light tunnel, it experiences multiple times of total reflections and exits at the output end as a rectangular beam. The spreading angle of the output light is as shown in FIG. 3. From the drawing, one sees that the spreading angle is about 38 degrees. Since this spreading angle is correlated to the rotation angle of the DMD chip, the light tunnel, the relay lens set, and the DMD chip have to be accurately aligned. Otherwise, the above-mentioned light leaking phenomenon is likely to happen.

Moreover, even if one is able to accurately control the relative positions among the light tunnel, the relay lens set, and the DMD chip, the light leaking phenomenon may still happen as a result of influences from other devices and the environment.

### SUMMARY OF THE INVENTION

To solve the foregoing problems, the invention provides a light-homogenizing device that greatly reduces the spreading angle of the output light to prevent light leaking.

The invention also provides an optical apparatus with a light-homogenizing device to prevent the light leaking phenomenon during the optical transportation process.

Moreover, the invention provides an optical apparatus with a light-homogenizing device to increase its contrast ratio.

The disclosed light-homogenizing device is installed between a light source and a light valve and has a light-entering surface and a light-exiting surface. The light-entering surface has a square shape, while the shape of the light-exiting surface matches that of the active region in the light valve.

In the above-mentioned light-homogenizing device, the size of the light-entering surface is slightly smaller than that of the light-exiting surface. Furthermore, the shape of the light-exiting surface may be a rectangle and the side of the light-entering surface is roughly equal to the shorter side of the light-exiting surface.

On the other hand, the light-entering surface can be close to the focal point of the light source. The focal point has a specific diameter. The light intensity within the focal point is over a specific threshold. The side length of the light-entering surface is roughly equal to the specific diameter. The light-entering surface can fall within the focal point.

The above-mentioned light-homogenizing device can be a transparent solid wedge or a hollow wedge. The inner surfaces of the hollow wedge are coated with a reflective layer.

Since the disclosed light-homogenizing device has a square light-entering surface and a rectangular light-exiting surface, although some optical energy is lost as light enters the device the spreading angle at the light-exiting surface can be greatly reduced through the reflection angle adjustment of the tilted sidewalls in the wedge structure. This can prevent light leaking.

The invention provides an optical apparatus with a light-homogenizing device for transmitting light homogeneously to a light valve. The apparatus comprises a light source, a light-homogenizing device, and a light valve. The light source provides light. The light-homogenizing device has a light-entering surface and a light-exiting surface for receiving light from the light source and outputting homogeneous light, respectively. The light valve has an active region for receiving light from the light-homogenizing device. The optical apparatus is characterized in that the light-entering surface has a square shape and the shape of the light-exiting surface matches with that of the active region in the light valve.

In the above-mentioned optical apparatus, the size of the light-entering surface is slightly smaller than that of the light-exiting surface. The light-exiting surface may also have a rectangular shape. The side of the light-entering surface is roughly equal in length to the smallest side of the light-exiting surface.

In the disclosed optical apparatus, the light valve may be a digital micro-mirror device (DMD) or a liquid crystal display (LCD).

Since the disclosed optical apparatus has a square light-entering surface and a rectangular light-exiting surface for the light-homogenizing device, although some optical energy is lost as light enters the device the spreading angle at the light-exiting surface can be greatly reduced through the reflection angle adjustment of the tilted sidewalls in the wedge structure. This can prevent light leaking.

Moreover, since the spreading angle of the disclosed light-homogenizing device becomes smaller, the incident angle of the beam into the light valve such as the DMD also becomes smaller. Therefore, it can greatly enhance the contrast ratio of the optical apparatus that uses the disclosed light-homogenizing device.

### BRIEF DESCRIPTION OF THE DRAWINGS

These and other features, aspects and advantages of the invention will become apparent by reference to the following description and accompanying drawings which are given by way of illustration only, and thus are not limitative of the invention, and wherein:

FIG. 1A is a schematic view of the structure of a conventional light tunnel;

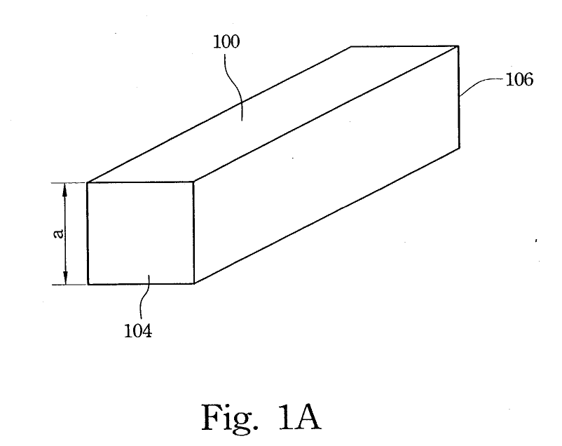

FIG. 1B is a schematic view of the structure of another conventional light tunnel;

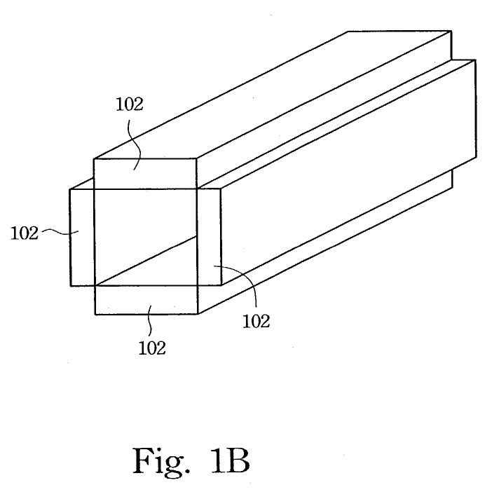

FIG. 2 shows a light intensity distribution at the focal point of a light source;

FIG. 3 shows the relation between the spreading angle at the light-exiting end and the light intensity for a conventional light tunnel;

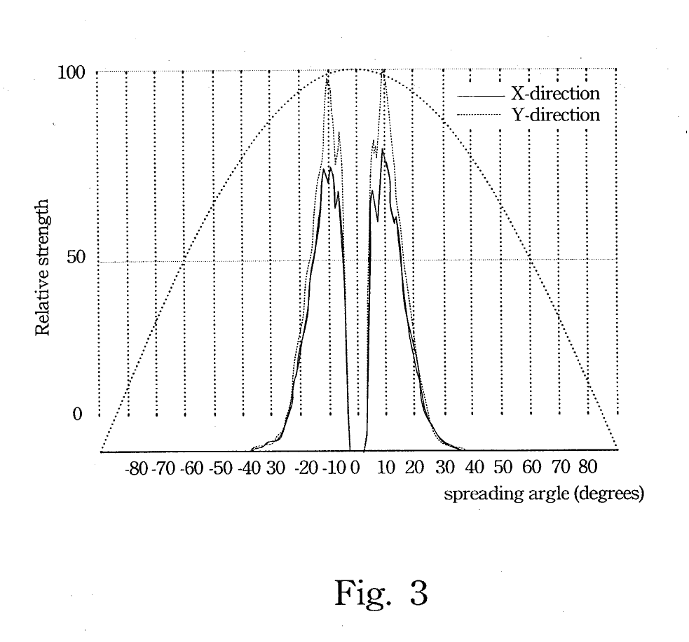

FIG. 4A is a schematic view of the structure of a light-homogenizing device according to a preferred embodiment of the invention;

FIG. 4B is a schematic view of the structure of a light-homogenizing device according to another embodiment of the invention;

FIG. 5 shows the relation between the spreading angle at the light-exiting end and the light intensity for a preferred embodiment of the invention;

FIG. 6 is a schematic view of the disclosed optical apparatus; and

FIG. 7 is a schematic view of the beam reflection in the disclosed light-homogenizing device.

### DETAILED DESCRIPTION OF THE PREFERRED EMBODIMENT

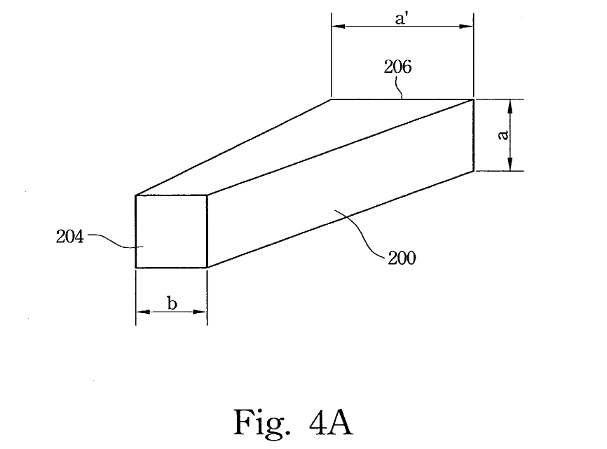

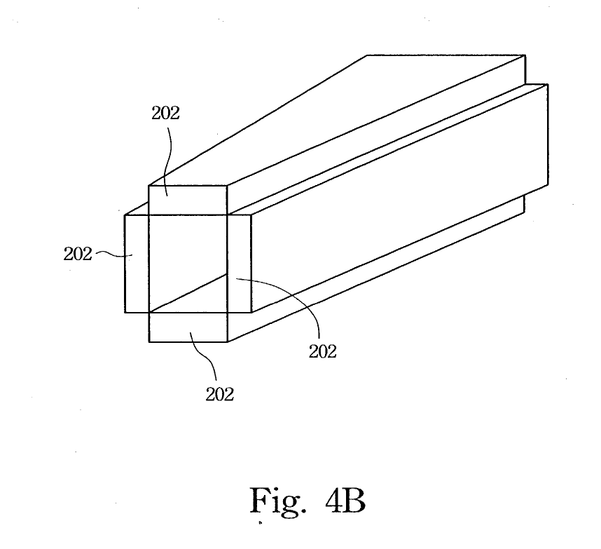

With reference FIG. 4A, the disclosed light-homogenizing device 200 has a wedge structure, which, for example, can be a transparent solid wedge made of glass. The light-homogenizing device 200 has a light-entering surface 204 and a light-exiting surface 206, and the size (or area) of the former is smaller than that of the latter. Moreover, the shape of the light-entering surface 204 is square (i.e. the aspect ratio equal to one). The shape of the light-exiting surface 206 matches that of the active region in the light valve such as the digital micro-mirror device (DMD) 312 to be mentioned later. For example, its shape can be rectangular (i.e. with an aspect ratio greater than one).

In the disclosed light-homogenizing device 200, suppose the side length of the light-entering surface 204 is b and the narrow side length (the shorter side length) of the light-exiting surface 206 is a. The length b can be roughly equal to a. Since the light-exiting surface 206 is generally a rectangle, therefore its wide side length a′ is usually greater than b. The light-homogenizing device 200 naturally forms a wedge structure with a spreading angle.

With reference to FIG. 4B, the light-homogenizing device of the invention can be a hollow wedge structure formed by four pieces of reflective walls 202. A reflective layer is coated on the inner surfaces of the structure.

When the light-homogenizing device 200 is placed near the focal point of a light source and the focal point is a light spot that contains more than a specific amount of energy within a specific diameter, then the length b of the light-entering surface 204 can be adjusted to be the same as the diameter or the light-entering surface 204 falls right within the focal point.

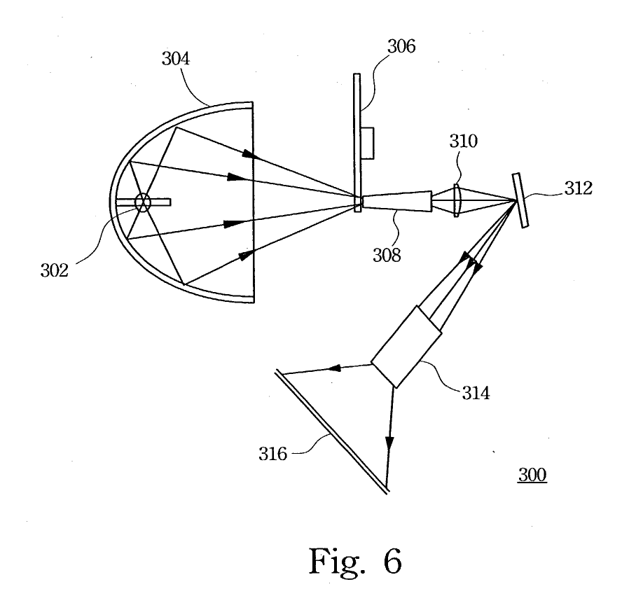

As shown in FIG. 6, the disclosed optical apparatus 300 contains a light source 302, a reflector 304, a color wheel 306, a light-homogenizing device 308, a relay lens set 310, a digital micro-mirror device (DMD) 312, a projection lens set 314, and a display screen 316.

The light-homogenizing device 308 is installed between the light source 302 and the DMD 312 to utilize its features mentioned before. The incident light is converted by the light-homogenizing device 308 and sent out as a beam with smaller spreading angle while higher accuracy to the DMD 312. The DMD can be replaced by other light valves such as the liquid crystal display (LCD).

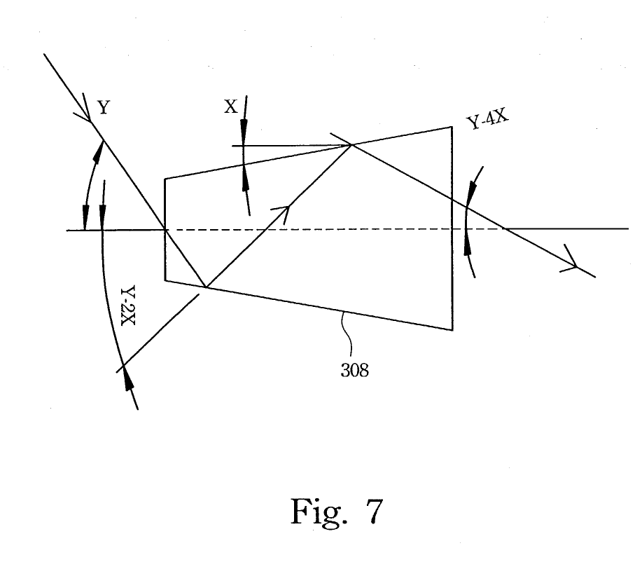

FIG. 7 shows how a light beam is reflected and how its angle changes after it enters the light-homogenizing device 308. As shown in the drawing, the light-homogenizing device 308 has an expanding angle x and the incident angle of the incident beam is y. From the reflection law, we know that the angle of a light beam is reduced by 2× each time it is reflected. Therefore, with an appropriate design of the expanding angle x, the angle of the outgoing beam can be effectively controlled. A smaller spreading angle of the beam makes the light scattering problem in the optical apparatus much easier to deal with, enhancing the contrast ratio of the system.

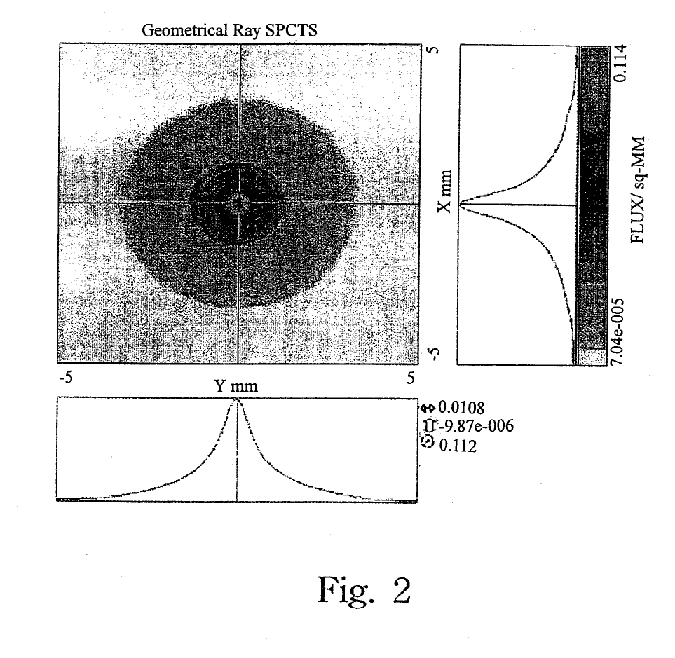

In the following, we use FIGS. 4A and 6 to explain how the disclosed optical apparatus 300 works. When the light source 302 emits light, it is focused by the reflector 304. After the color-filtering by the color wheel, the beam is converged on the light-entering surface 304 of the disclosed light-homogenizing device 308. At this moment, the light intensity distribution on the focal light spot is as in FIG. 2.

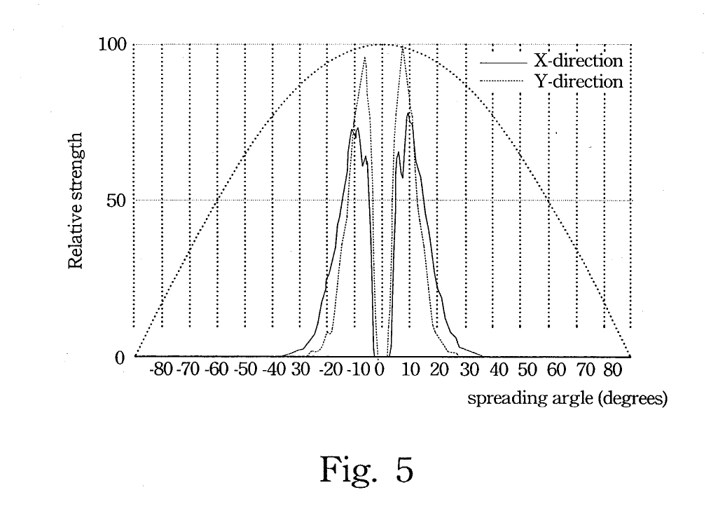

Afterwards, light experiences total reflections on the tilted sidewalls of the light-homogenizing device 308 and leaves its light-exiting surface. At this moment, the beam spreading angle distribution on the light-exiting surface is as shown in FIG. 5. From the data given in the drawing, we know that the spreading angle thus obtained is around 28 degrees. In comparison with the light tunnel in the prior art (with a spreading angle of about 38 degrees), the spreading angle of the invention is reduced by 10 degrees.

Light exiting the light-homogenizing device 308 is mediated by the relay lens set 310 to the DMD 312. As the spreading angle of the invention is very small, no light leaking occurs when the DMD 312 switched between on and off. In addition, the light is projected by the projection lens set 314 to the display screen 316 through such switches of the DMD 312.

In summary, the disclosed light-homogenizing device has a square light-entering surface and a rectangular light-exiting surface. Although some optical energy is lost as light enters the device the spreading angle at the light-exiting surface can be greatly reduced through the reflection angle adjustment of the tilted sidewalls in the wedge structure. This can prevent light leaking.

The disclosed optical apparatus has a square light-entering surface and a rectangular light-exiting surface for the light-homogenizing device. Likewise, although some optical energy is lost as light enters the device the spreading angle at the light-exiting surface can be greatly reduced through the reflection angle adjustment of the tilted sidewalls in the wedge structure. This can prevent light leaking.

Moreover, since the spreading angle of the disclosed light-homogenizing device becomes smaller, the incident angle of the beam into the light valve such as the DMD also becomes smaller. Therefore, it can greatly enhance the contrast ratio of the optical apparatus that uses the disclosed light-homogenizing device.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A light-homogenizing device having a wedge structure with an expanding angle, wherein the wedge structure has a light-entering surface and a light-exiting surface, featured in that:
the light-entering surface has a square shape; and
the light-exiting surface has a rectangular shape.

2. The light-homogenizing device of claim 1, wherein the aspect ratio of the light-exiting surface is greater than 1.

3. The light-homogenizing device of claim 1, wherein the side length of the light-entering surface is roughly equal to the shorter side length of the light-exiting surface.

4. The light-homogenizing device of claim 1, wherein the wedge structure is a solid transparent wedge.

5. The light-homogenizing device of claim 4, wherein the material of the solid transparent wedge includes glass.

6. The light-homogenizing device of claim 1, wherein the wedge structure is a hollow wedge with its inner surface coated with a reflective layer.

7. A light-homogenizing device placed between a light source and a light valve, wherein the light-homogenizing device has a light-entering surface and a light-exiting surface featured in that:
the light-entering surface has a square shape; and
the shape of the light-exiting surface matches with that of the active region in the light valve.

8. The light-homogenizing device of claim 7, wherein the side length of the light-entering surface is roughly equal to the shorter side length of the light-exiting surface.

9. The light-homogenizing device of claim 7, wherein the light-entering surface is near a focal point of the light source and the focal point has a specific diameter within which the light intensity is higher than a specific threshold.

10. The light-homogenizing device of claim 9, wherein the side length of the light-entering surface is roughly equal to the diameter.

11. The light-homogenizing device of claim 9, wherein the light-entering surface falls within the focal point.

12. The light-homogenizing device of claim 7 having an expanding angle.

13. An optical apparatus with a light-homogenizing device for delivering homogeneous light to a light valve, comprising:
a light source, which provides needed light;
a light-homogenizing device, which has a light-entering surface and a light-exiting surface for receiving light from the light source and outputting homogenous light, respectively; and
a light valve, which has an active region for receiving light from the light-homogenizing device;
wherein the light-entering surface has a square shape, and the shape of the light-exiting surface matches with that of the active region in the light valve.

14. The optical apparatus of claim 13, wherein the side length of the light-entering surface is roughly equal to the shorter side length of the light-exiting surface.

15. The optical apparatus of claim 13, wherein the light-entering surface is near a focal point of the light source and the focal point has a specific diameter within which the light intensity is higher than a specific threshold.

16. The optical apparatus of claim 15, wherein the side length of the light-entering surface is roughly equal to the diameter.

17. The optical apparatus of claim 15, wherein the light-entering surface falls within the focal point.

18. The optical apparatus of claim 13, wherein the light-homogenizing device has an expanding angle.

19. The optical apparatus of claim 13, wherein the light valve is a digital micro-mirror device (DMD).

20. The optical apparatus of claim 13, wherein the light valve is a liquid crystal device (LCD).
